(19) United States
(12) Patent Application Publication
(10) Pub. No.: US 2014/0336271 A1
(43) Pub. Date: Nov. 13, 2014

(54) Antimicrobial Compositions Containing Carvacrol and Thymol

(71) Applicant: Kemin Industries, Inc., Des Moines, IA (US)

(72) Inventors: Sally Moore, Ankeny, IA (US); Mitchell Poss, Johnston, IA (US)

(21) Appl. No.: 14/272,071

(22) Filed: May 7, 2014

Related U.S. Application Data
(60) Provisional application No. 61/820,455, filed on May 7, 2013.

(51) Int. Cl. A01N 31/08

(52) U.S. Cl. CPC A01N 31/08
USPC 514/731

(57) ABSTRACT

Compositions having a combination of carvacrol and thymol are found to have synergistic antimicrobial activity against feed pathogens.

This application claims priority to U.S. Patent Application Ser. No. 61/820,455, filed May 7, 2013, and incorporates the same herein in its entirety by this reference.

### BACKGROUND OF THE INVENTION

The present invention relates generally to compounds having antimicrobial properties and, more specifically to the antimicrobial properties of carvacrol and thymol.

Antibiotic use in animal production worldwide is being challenged more than ever, and in many countries the use of certain antibiotics has been banned (Windisch, W., K. Schedle, C. Plitzner and A. Kroismayr. 2008. Use of phytogenic products as feed additives for swine and poultry. J. Anim. Sci. 86 (E Suppl): E140-E148). While many synthetic molecules are effective against foodborne pathogens, the use of “natural” molecules such as those derived from plants and probiotics are gaining attention as alternatives to antibiotic use. Carvacrol and thymol are two components of oregano oil that confer antimicrobial activity against both gram negative (G−) and gram positive (G+) bacteria and the effectiveness of these compounds is well documented in the literature (Helender, I., H-L. Alakomi, K. Latva-Kala, T. Mattila-Sandholm, I. Pol, E. Smid, L. Gorris and A. von Wright. 1998. Characterization of the action of selected essential oil components on gram negative bacteria. J. Agric. Food Chem. 46:3590-3595; Sokovic, M., P. Marin, D. Brkic and L. van Griensven. 2007. Chemical composition and antibacterial activity of essential oils of ten aromatic plants against human pathogenic bacteria. Food:Global Science Books; Derwich, E., Z. Benziane, A. Manar, A. Boukir and R. Taouil. 2010. Phytochemical analysis and in vitro antibacterial activity of the essential oil of Origanum vulgare from Morocco. Am-Euras. J. Sci. Res. 5 (2): 120-129; Michiels, J., J. Missotten, D. Fremaut, S. De Smet and N. Dierick. 2007. In vitro dose-response of carvacrol, thymol, eugenol and trans-cinnamaldehyde and interaction of combinations for the antibicorbial activity against the pig gut flora. Livestock Science 109: 157-160; Bajpai, V., K-H. Baek, and S. Kang. 2011. Control of Salmonella in foods by using essential oils: a review. Food Research International. Article in Press). The accepted mode of action for essential oils is the hydrophobicity of the oils which enables them to penetrate the outer cell membrane of gram-negative bacteria disrupting the membrane structure and causing ion leakage (Windisch et al., 2008; Rasooli, I., 2007. Food preservation—a biopreservative approach. Food. Global Science Books; Guarda, A. J. Rubilar, J. Miltz and M. Galotto. 2011. The antimicrobial activity of microencapsulated thymol and carvacrol. Int. J. Food Microbiol. 146:144-1580). It is documented that essential oils demonstrating the highest degree of microbial inhibition contain high levels of phenolic compounds such as carvacrol and thymol (Rasooli, 2007). Carvacrol and thymol are structural isomers possessing a hydroxyl group at different positions on the phenolic ring. The antimicrobial activity of both molecules is similar and does not appear to be affected by the position of the hydroxyl group (Rasooli, 2007).

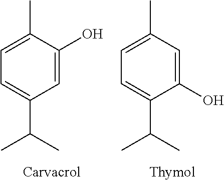

The levels of carvacrol and thymol inhibitive to microbial growth can vary depending on the challenge organism and the test methodology (Rasooli, 2007). Consequently, the minimum inhibitory concentrations (MIC) effective to inhibit the growth of selected microorganisms were determined in a microtiter plate assay using carvacrol and thymol standards. Microtiter plate assays are commonly used and convenient due to the low volume of test material required, easy preparation of replicate wells, ability to screen multiple treatment levels and the ability to combine antimicrobials for observation of synergistic, additive or antagonistic effects (Rasooli, 2007).

Several competitive products are currently being marketed by Ralco, Meriden, DSM, Biomin and Delacon. Kemin's Specialty Crop Improvement (SCI) program is developing oregano plant lines that contain >5% carvacrol (dry weight basis) and >3.8% thymol (dry weight basis). The oils extracted from these plants will be used to develop a new antimicrobial product for animal feed and blended in a proprietary formulation making a unique product for introduction into the feed additive market.

### SUMMARY OF THE INVENTION

The primary objective of this work was to determine the most efficacious blend of oils high in carvacrol and thymol that would result in the inhibition of selected food safety pathogens—E. coli and Salmonella Enteritidis. The effect of treatment to beneficial gut bacteria such as lactic acid bacteria as well as Bacillus subtilis PB6—the active microbial in CLOSTAT® _{brand} Dry Direct-Fed Microbial (Kemin Industries, Des Moines, Iowa)—was also determined.

The minimum inhibitory concentrations (MICs) of carvacrol and thymol in the essential oils extracted from oregano plants were determined via microtiter plate assays. Either 3×3 or 4×4 matrices were used to evaluate the antimicrobial effects of carvacrol and thymol individually or in combinations. Both carvacrol (98%) and thymol (99.5%) inhibited the growth of both S. Enteritidis and E. coli at levels greater than 125 ppm but less than 250 ppm. Carvacrol in the extracted oil at either 80% or 68% required >175 or >200 ppm carvacrol, respectively, to inhibit both organisms. Thymol was a constant concentration in the oil at 70% and required >200 ppm to inhibit the same two organisms. The work presented here supports combinations of the oil containing 68% or 80% carvacrol and the oil containing 70% thymol resulting in a 2:1 or 1:2 carvacrol:thymol ratio were effective in the growth inhibition of S. Enteritidis and E. coli.

### BRIEF DESCRIPTION OF THE FIGURES

FIGS. 1A-1C are charts of the kinetic growth curves showing the effects of the standards—C (carvacrol), T (thymol) or C:T (carvacrol:thymol)—on S. Enteritidis (A), E. coli (B) and Bacillus subtilis strain PB6 (C); refer to Table 1 for the formulations.

FIGS. 2A and 2B are charts showing the endpoint growth curves showing the effects of the standards—C, T or C:T—on S. Enteritidis (A) and PB6 (B); refer to Table 2 for the formulations.

FIGS. 3A and 3B are charts of the kinetic growth curves showing the effects of treatment—HC (high carvacrol), HT (high thymol) or HC:HT (high carvacrol:thymol)—on E. coli (A) and PB6 (B) using oregano oil extracted from plants. The treatment levels of the extracted oils were adjusted to match previous levels when using the carvacrol and thymol standards; refer to Table 3 for the treatment formulations.

FIGS. 4A-4D are charts of the kinetic growth curves showing the effects of treatment—HC, HT or HC:HT oils.

### DESCRIPTION OF THE INVENTION

Oregano plants have long been recognized as a source of carvacrol and thymol. Accessions of oregano vary widely in the amounts of carvacrol and thymol produced by the plants. Our research has shown that some accessions produce carvacrol predominantly over thymol while other accessions produce thymol predominantly over carvacrol. Conventional plant breeding techniques were used to produce clonal lines of oregano that had greater than 20 mg/g carvacrol, at 50 mg/g and up to at least 69.7 g/mg carvacrol on a dry matter basis. These high carvacrol lines typically had low levels of thymol, ranging from between a ratio of carvacrol to thymol of 10:1, 50:1 and up to at least 713:1. In addition, conventional plant breeding techniques were used to produce clonal lines of oregano that had greater than 7 mg/g thymol, at 30 mg/g and up to at least 38.5 g/mg thymol on a dry matter basis. These high thymol lines typically had low levels of carvacrol, ranging from between a ratio of thymol to carvacrol of 5:1, 10:1 and up to at least 49.7:1.

Inhibitory levels were first determined using carvacrol and thymol standards. Subsequently, the HC:HT oils extracted from plants grown internally were blended achieving the targeted levels of carvacrol and thymol. Further inhibition assays were conducted to verify the effectiveness of the oil blend.

Standards.

Thymol and carvacrol were purchased from Sigma-Aldrich Chemical Company.

Oregano Oil.

The oregano oil used in these experiments was extracted from plants grown internally. Plant lines containing high carvacrol levels (HC) were identified. Specifically, the high carvacrol strain KI-Ov1750, which is the subject of U.S. Patent Application Ser. No. 61/855,067, filed May 7, 2013 (which is incorporated herein in its entirety by this reference), was developed. The oil extracted from the HC plant lines was combined and resulted in a carvacrol level of 67.7% (thymol level of 0.93%). Plant lines containing high thymol levels (HT) were identified. Specifically, the high thymol strain KI-Ov1850, which is the subject of U.S. Patent Application Ser. No. 61/855,068, filed May 7, 2013 (which is incorporated herein in its entirety by this reference), was developed. The oil extracted from HT oregano plant lines plant lines resulted in a thymol level of 70% (carvacrol level of 8.3%).

Microbial Cultures.

Stock cultures of Escherichia coli 413-1, ATCC 25922, Salmonella Enteritidis, ATCC 13076, Bacillus subtilis PB6 (Kemin Industries) and Lactobacillus johnsonii D115 (Kemin Industries) were cultured from agar plates held at 4° C. and inoculated into tubes of either Tryptic Soy Broth (TSB) or de Man, Rogosa and Sharpe (MRS) broth. The bacteria were incubated aerobically or anaerobically as appropriate at 37° C. for 20-22 h. All microbial cultures used in this work are strains maintained in an in-house culture collection.

Treatment Preparation—Standards (Tables 1 and 2).

Stock solutions of 1000 ppm each of carvacrol and thymol standards were prepared in sterile TSB to which 0.1% agar was added for stabilization of the oil:water emulsion (Rasooli et al., 2007; Burt, S. and R. Reinders. 2003. Antibacterial activity of selected plant essential oils against Escherichia coli O157:H7. Letters Appl. Microbiol. 36:162-167). Subsequent dilutions and/or combinations of the standard stock solutions were prepared in TSB to achieve the targeted inclusion level of each molecule.

Treatment Preparation—Extracted Oils (Tables 3 and 4).

Stock solutions of 1000 ppm were made of each of the HC and HT extracted oils in sterile TSB or MRS broth to which 0.1% agar was added. Subsequent dilutions and/or combinations of the extracted oil stock solutions were prepared in TSB or MRS to achieve the targeted inclusion level of each molecule.

Blended Oils.

The extracted oils were blended in a 2:1 ratio (v/v) of HC:HT.

Treated Agar Assay.

Liquid Mueller Hinton agar was treated with the blended oil achieving treatment levels of 0.02% to 0.5% (200-5000 ppm) and allowed to solidify. A 0.5 mL aliquot of either E. coli or S. Enteritidis was inoculated onto the surface of separate plates and allowed to dry at room temperature under laminar flow. All plates were refrigerated 2 h followed by aerobic incubation at 37° C. for 20 h. The plates were not sealed. Visual observations were made to determine if growth was present at a specific treatment level.

Microtiter Plate Assay.

The efficacy of carvacrol and thymol in the inhibition of microbial growth was evaluated in a microtiter plate assay measuring the optical density at 620 nm using an Optimax microtiter plate reader (Molecular Devices, Sunnyvale, Calif.). Plates were read kinetically (aerobic organisms) or endpoint (anaerobic organisms) over 20-24 h while maintaining temperature at 35° C. All results reflect the average optical density measurements of four microtiter wells. A 100 uL aliquot of a test organism (1.0E+06 cfu/mL) in sterile saline and a 100 μL aliquot of experimental treatment were dispensed into individual microtiter plate wells. Treatments prepared in TSB were used for E. coli, S. Enteritidis and PB6 while treatments prepared in MRS broth were used for L. johnsonii D115. Positive controls consisted of 100 μL of test organism in sterile saline and 100 μL of sterile TSB or MRS. Negative controls were made of 100 μL of sterile TSB or MRS and 100 μL of sterile saline (no organisms).

Treatments.

The inhibitory levels of carvacrol and thymol against selected microorganisms were evaluated through several formulation matrices designed to assess the individual molecules as well as combinations of the molecules. Initially, thirteen formulations were prepared according to the incomplete 4×4 matrix design in Table 1 using 0, 125, 250 and 500 ppm each of carvacrol standard and thymol standard to evaluate the inhibitory activity toward selected microorganisms. In all instances formulas are noted as F1, F2, etc. Subsequent matrices were designed to fine-tune inclusion levels of carvacrol and thymol.

TABLE 1
A 4x4 matrix design of 13 combinations of carvacrol
standard (98%) and thymol standard (99.5%)

Carvacrol (ppm)

| | | 0 | 125 | 250 | 500 |
|---|---|---|---|---|---|
| Thymol | 0 | F1 | F2 | F3 | F4 |
| (ppm) | 125 | F5 | F6 | F7 | F8 |
| | 250 | F9 | F10 | F11 | F12 |
| | 500 | F13 | NA | NA | NA |

A second incomplete 4×4 matrix of 15 formulations (Table 2) was created to evaluate the inhibition of selected microorganisms using reduced levels of carvacrol standard and thymol standard.

TABLE 2
A 4x4 matrix design of 16 combinations of carvacrol
standard (98%) and thymol standard (99.5%) at reduced
levels based on assays results from Table 1

Carvacrol (ppm)

| | | 0 | 31.25 | 62.5 | 125 |
|---|---|---|---|---|---|
| Thymol | 0 | F1 | F2 | F3 | F4 |
| (ppm) | 31.25 | F5 | F6 | F7 | F8 |
| | 62.5 | F9 | F10 | F11 | F12 |
| | 125 | F13 | F14 | F15 | F16 |

A third matrix of 9 formulas (Table 3) was created using oil from oregano plants grown by SCI and extracted on site. The treatment levels chosen were based on activity levels observed in previous experiments using carvacrol and thymol standards. For example, if 125 ppm of a 98% carvacrol standard was sufficient to inhibit the growth of a selected bacteria, then 180 ppm of extracted oil containing 68% carvacrol would be required to observe the same effect.

TABLE 3
A 3x3 matrix design of 9 combinations using oil extracted from
oregano plants harvested by SCI. The HC oregano plants contained
68% carvacrol while the HT oregano plants contained 70% thymol

HC oil (ppm)

| | | 0 | 100 | 200 |
|---|---|---|---|---|
| HT | 0 | F1 | F2 | F3 |
| oil | 100 | F4 | F5 | F6 |
| (ppm) | 200 | F7 | F8 | F9 |

A fourth matrix of 9 formulations was prepared using SCI oregano oil of 68% carvacrol but supplemented with carvacrol standard to achieve an 80% carvacrol level. The HT oil was used as extracted. Treatment levels were targeted based on previous results.

TABLE 4
A 3x3 matrix design of 9 formulations using oil extracted
from SCI oregano plants where the HC oil was supplemented
with carvacrol standard to achieve an 80% carvacrol level

HC oil (ppm)

| | | 0 | 87.5 | 175 |
|---|---|---|---|---|
| HT | 0 | F1 | F2 | F3 |
| oil | 87.5 | F4 | F5 | F6 |
| (ppm) | 175 | F7 | F8 | F9 |

### Results

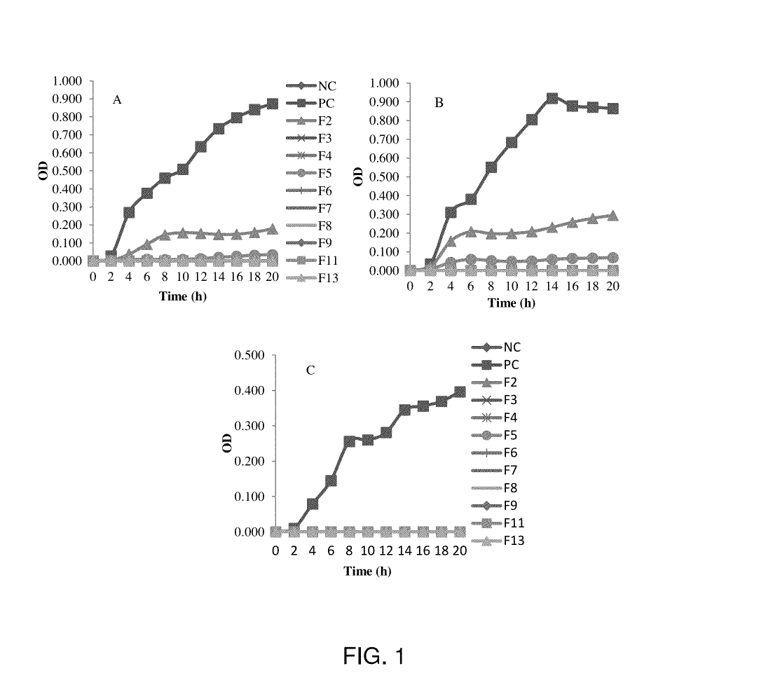

The initial assays using treatment levels in Table 1 showed that >125 ppm but <250 ppm of either carvacrol (C) or thymol (T) was needed to completely inhibit the growth of gram negative bacteria S. Enteritidis and E. coli in microtiter assays (FIGS. 1A and 1B). However, a carvacrol:thymol ratio (C:T) of 125 ppm carvacrol to 125 ppm thymol (F6, Table 1) was adequate to inhibit the growth of both organisms. B. subtilis PB6 was more affected by treatment and growth was inhibited by either 125 ppm carvacrol (F2, Table 1) or 125 ppm thymol (F5, Table 1) (FIG. 1C).

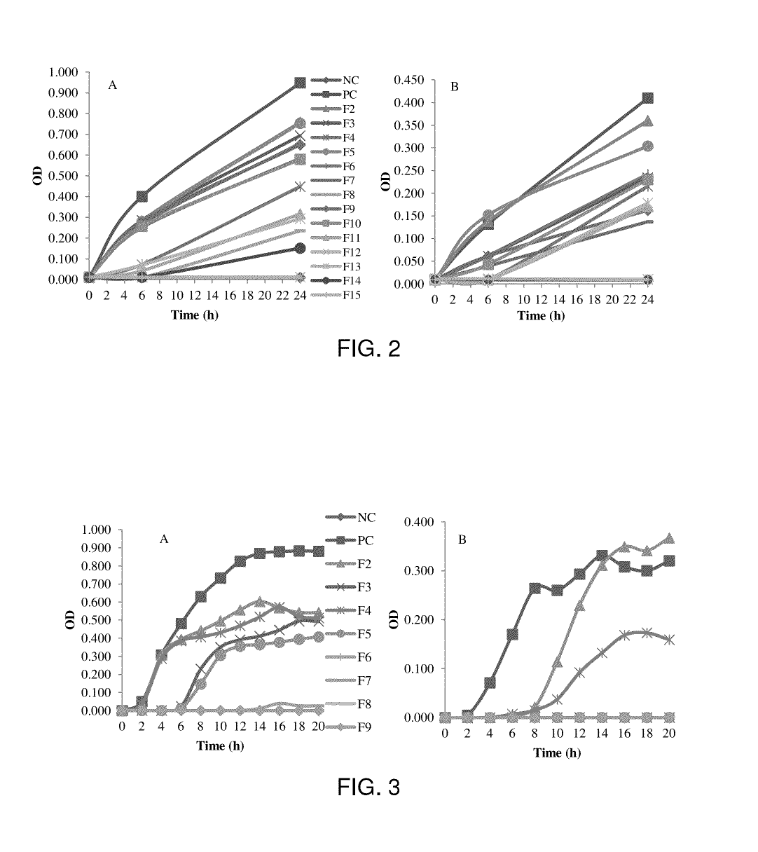

Treatment levels of carvacrol and thymol below 125 ppm (FIGS. 2A and 2B) showed clear treatment effects. Neither treatment of carvacrol at 125 ppm (F4, Table 2) nor treatment of thymol of 125 ppm (F13, Table 2) was sufficient to inhibit the growth of S. Enteritidis or PB6. However, the addition of 62.5 ppm thymol—resulting in a C:T ratio of 125:62.5 (F12, Table 2)—inhibited growth of S. Enteritidis while a C:T ratio of 125:31.25 (F8, Table 2) inhibited the growth of PB6. Similarly, carvacrol:thymol ratios of 62.5:125 (F15, Table 2) and 31.25:125 (F14, Table 2) were sufficient to inhibit the growth of S. Enteritidis and PB6, respectively. In this experiment, endpoint measurements were used due to the number of treatments involved and multiple plates being required.

The inhibitory effects of the oregano oil extracted from plants grown by SCI were evaluated. In this experiment, both carvacrol and thymol levels in the extracted oils were normalized to the standards to observe any further benefits the extracted oil contributed to overall microbial inhibition. For example, 125 ppm of a 98% carvacrol standard was needed to achieve inhibition when combined with thymol; therefore, 180 ppm of the 68% high carvacrol oil was used in the matrix formulations (FIGS. 3A and 3B).

The carvacrol level in the SCI extracted oil was increased from 68% to 80% using carvacrol standard and verified via HPLC analysis. The thymol level in the extracted oil was maintained at 70%. Using the results previously achieved with carvacrol included at different levels, treatment levels were selected and inhibition of microorganisms was evaluated.

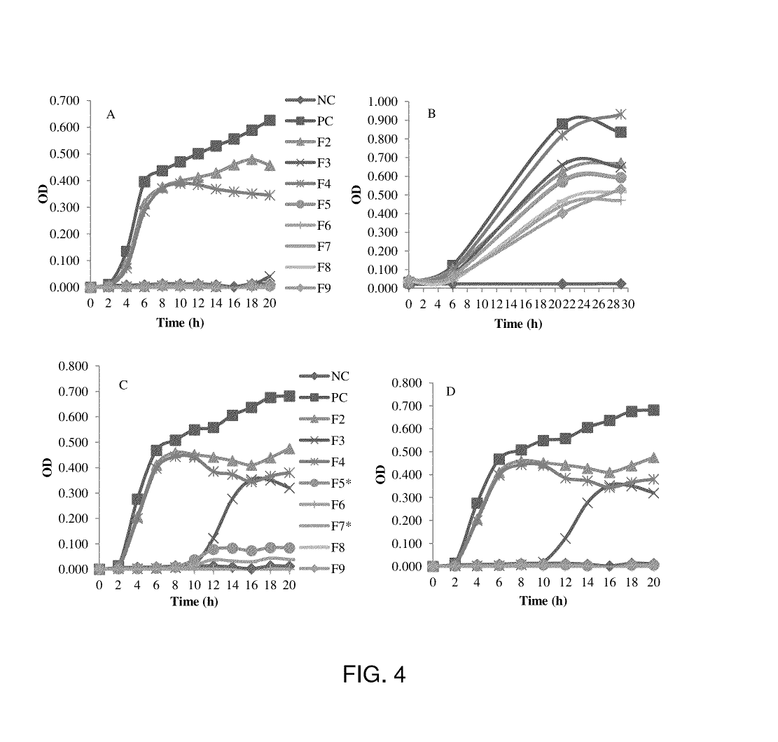

FIGS. 4A-4D are charts showing the kinetic growth curves showing the effects of treatment—HC, HT or HC:HT oils—using oregano oil extracted from plants grown by SCI. The level of carvacrol in the extracted HC oil was increased to 80%. The effects to the growth of S. Enteritidis and L. johnsonii D115 are shown in graphs A and B, respectively. Graphs C and D reflect the effect of treatment on E. coli. One well in each of series F5 and F7 showed growth and could have been inadvertent contamination or variability in the inoculum used in the wells. Graph C includes the readings from all 4 wells while graph D does not include the well with growth. While there is minimal difference, this could be indicative of the “borderline” treatment level of F5.

Oregano oil at treatment levels above 500 ppm interfered with the optical density readings of the microtiter plate assay resulting in negative OD values. To observe the effect on microbial growth at the higher levels of the blended oils, a treated agar assay was conducted and evaluated for growth/no growth. While previous microtiter screenings had shown that 300 ppm of the blended oils was effective in E. coli and S. Enteritidis inhibition, a wide range of treatment levels was evaluated.

TABLE 5
Effect of oregano oil blended at a 2:1 ratio (HC:HT) on the growth
of E. coli and S. Enteritidis. The carvacrol level is 68%.

| Treatment | Treatment | Level of | Level of | | |
|---|---|---|---|---|---|
| Level | Level | Carvacrol | Thymol | | S. |
| (ppm) | (kg/T) | (ppm) | (ppm) | E. coli | Enteritidis |
| 0 | 0 | 0 | 0 | Positive | Positive |
| 200 | 0.2 | 90 | 46 | Positive | Positive |
| 500 | 0.5 | 225 | 115 | Negative | Negative |
| 1000 | 1.0 | 450 | 230 | Negative | Negative |
| 5000 | 5.0 | 2250 | 1150 | Negative | Negative |

### Discussion

There are a number of commercially available products containing oregano oil on the market today. However, one has not been found that is marketed to contain high levels of both carvacrol and thymol. The HC and HT oregano oils provided by SCI were tested individually and in combinations to determine the MICs for two foodborne pathogens. The levels found to be inhibitive to S. Enteritidis and E. coli (FIG. 2) were similar to those reported in the literature in similar type assays (Sokovic, et al., 2007; Bajpai, et al., 2011; Ait-Ouazzou, A., L. Cherrat, L. Espina, S. Loran, C. Rota and R. Pagan. 2011. The antimicrobial activity of hydrophobic essential oil constituents acting alone or in combined processes of food preservation. Innovative Food Science and Emerging Technologies. 12:320-329). Animal feeding studies will be conducted to determine if these levels are suitable as determined by animal acceptance, improvements in targeted production parameters and overall cost of the treatment.

Carvacrol and thymol were found to be equally effective in the inhibition of E. coli and S. Enteritidis at the levels tested. As expected, higher concentrations of either of these molecules resulted in lower effective treatment levels. The absolute endpoint for efficacy of each molecule was not determined as the focus was to determine the lowest inclusion levels of each molecule in a blended product. The blended oils showed the most efficacy at a 2:1 HC oil:HT oil or HT oil:HC oil ratio. This was also observed when using carvacrol and thymol standards. Carvacrol and thymol are structural isomers displaying similar inhibitory activity (Michiels, et al., 2007). It has been reported that the effects of carvacrol and thymol were additive in their inhibitory activity (Burt, S., R. Vlielander, H. Haagsman and E. Veldhuizen. 2005. Increase in activity of essential oil components carvacrol and thymol against Escherichia coli 0157.H7 by addition of food stabilizers. J. Food Protection 68(5):919-926). Because the level of carvacrol and thymol and other potentially bioactive components differ with oregano plant line, time of harvest, conditions of oil extraction, etc., it is important to determine the levels present in each batch of oil extracted. Table 6 highlights the different MICs based on different levels of carvacrol and thymol resulting from the experiments conducted. A carvacrol level of 80% was included for two reasons: 1) a major competitor markets an oregano oil product containing 80% carvacrol, and 2) it was of interest to observe the effect to treatment levels at a point between the standards and the SCI oil as extracted.

TABLE 6
Inhibitory C:T combinations (ppm) with varying concentrations
of carvacrol and thymol from either standard solutions or extracted
oils against G(−) and G(+) bacteria. The inhibitory C:T
ratio of SCI oils reflect the adjustment to lower carvacrol and
thymol levels in the oils compared to standard solutions.

| | | Inhibitory C:T levels (ppm) | | | |
|---|---|---|---|---|---|
| | | | S. | L. | |
| Treatment | Source | E. coli | Enteritidis | johnsonii | PB6 |
| 98% | Sigma- | 125:62.5 | 125:62.5 | ND | 125:31.25 |
| carvacrol | Aldrich | or | or | | or |
| 99.5% | | 62.5:125 | 62.5:125 | | 31.25:125 |
| thymol | | | | | |
| 80% | SCI oils | 175:87.5 | 175:87.5 | >175:>175 | ND |
| carvacrol | | or | or | | |
| (adjusted | | 87.5:175 | 87.5:175 | | |
| w/std) | | | | | |
| 70% | | | | | |
| thymol | | | | | |
| 68% | SCI oils | 200:100 | 200:100 | ND | 100:100 |
| carvacrol | | or | or | | |
| 70% | | 100:200 | 100:200 | | |
| thymol | | | | | |

Generally G(+) organisms are more sensitive to the inhibitory effects of essential oils (Sokovic, et al., 2007; Guarda, et al., 2011; Ait-Ouazzou, et al., 2011; Ivanovic, J., D. Misic, I. Zizovic and M. Ristic. 2012. In vitro control of multiplication of some food-associated bacteria by thyme, rosemary and sage isolates. Food Control 25:110-116). This is supported by the C:T ratio of 125:31.25 ppm for PB6 (G+) observed in this work. As noted in Table 6, the C:T ratios for E. coli (G−) and S. Enteritidis (G−) are higher than that for B. subtilis PB6 (G+). Gram (−) organisms are more tolerant due to the hydrophilic outer membrane which blocks entry of the hydrophobic essential oil (Ait-Ouazzou, et al., 2011). Bacillus species were especially sensitive to thyme essential oil (Ait-Ouazzou, et al., 2011). While 125 ppm inhibited the growth of PB6 as noted in FIG. 1, it was not sufficient to inhibit growth as noted in FIG. 2. This may be indicative of a borderline treatment effect. Work conducted by J. Michiels, et. al reported that carvacrol and thymol inhibited the growth of E. coli and Lactobacillus similarly while work by Mathlouthi, et al. found Lactobacillus not sensitive to essential oils (Mathlouthi, N. T. Bouzaienne, I. Oueslati, F. Recoquillay, M. Hamdi, M. Urdaci and R. Bergaoui. 2011. Use of rosemary, oregano, and commercial blend of essential oils in broiler chickens: in vitro antimicrobial activities and effects on growth performance J. Anim. Sci. 2012. 90:813-823). In the experiments conducted here, L. johnsonii was less sensitive to the effects of treatment than was E. coli. As noted in Mathlouthi's publication, differences in results are often observed and can be attributed to differences in microbial strains, methodologies, concentration of active compounds, etc.

As noted earlier, higher levels of the essential oil blend interfered with the OD readings of the microtiter assay necessitating an alternate methodology. The agar plate assay (Table 5) compared nicely with the microtiter assay in this work. The agar plate assay indicated that >200 ppm but <500 ppm of a 2:1 HC:HT blended oil product (68% carvacrol and 70% thymol) would inhibit the growth of E. coli and S. Enteritidis. The microtiter assay (Table 6) resulted in 300 ppm of the same blend being the best level for growth inhibition. It was impossible not to detect the odor of oregano oil in the laboratory. While the agar plates were not sealed during incubation, the microtiter plates were. Effective treatment levels were comparable.

In addition to the documented antimicrobial activity of oregano oil, this essential oil has also been cited in the literature to have anti-coccidial effects in broilers as well as indications that carvacrol and thymol may play a role in the inhibition of biofilm formation (Tsinas, A., Il Giannenas, C. Voidarou, A. Tzora and J. Skoufos. 2011. Effects of an oregano based dietary supplement on performance of broiler chickens experimentally infected with Eimeria Acervulina and Eimeria Maxima. J. Poult. Sci. 48:194-200; Giannenas, I., P. Florou-Paneri, M. Papazahariadou, E. Christaki, N. A. Botsoglou and A. B. Spais. 2003. Effect of dietary supplementation with oregano essential oil on performance of broilers after experimental infection with Eimeria Tenella. Arch. Anim. Nutr. 57(2):99-106; Soumya, E., I. Saad, L. Hassan, Z. Ghizlane, M. Hind and R. Adnane. 2011. Carvacrol and thymol components inhibiting Pseudomonas aeruginosa adherence and biofilm formation. African J. of Microbiol Res. 5(20):3229-3232).

The oregano oil available on the market today typically contains >60% carvacrol but thymol levels are 4% or less. A blended oil product containing high levels of both carvacrol and thymol will provide an additional “hurdle” for the pathogens to overcome.

The foregoing description and drawings comprise illustrative embodiments of the present inventions. The foregoing embodiments and the methods described herein may vary based on the ability, experience, and preference of those skilled in the art. Merely listing the steps of the method in a certain order does not constitute any limitation on the order of the steps of the method. The foregoing description and drawings merely explain and illustrate the invention, and the invention is not limited thereto, except insofar as the claims are so limited. Those skilled in the art whom have the disclosure before them will be able to make modifications and variations therein without departing from the scope of the invention.

We claim:

1. A blend of plant extracts, comprising a combined amount of carvacrol and thymol that is more effective as an antimicrobial than an equivalent amount of carvacrol alone or thymol alone.

2. A blend of extracts as defined in claim 1, wherein the ratio of carvacrol to thymol is between 1:4 and 4:1.

3. A blend of extracts as defined in claim 2, wherein the ratio of carvacrol to thymol is between 1:3 and 3:1.

4. A blend of extracts as defined in claim 3, wherein the ratio of carvacrol to thymol is between 1:2 and 2:1.

5. A blend of extracts as defined in claim 1, wherein the ratio of carvacrol to thymol is between 1.5:1 and 1:2.5.

6. A blend of extracts as defined in claim 1, wherein the ratio of carvacrol to thymol is between 1:1.5 and 2.5:1.

7. A blend of extracts as defined in claim 1, wherein said carvacrol is obtained from an oregano plant that contains not less than 20 mg/g carvacrol on a dry matter basis.

8. A blend of extracts as defined in claim 7, wherein said carvacrol is obtained from an oregano plant that contains not less than 50 mg/g carvacrol on a dry matter basis.

9. A blend of extracts as defined in claim 1, wherein said carvacrol is obtained from an oregano plant that has a ratio of carvacrol to thymol of at least 10:1.

10. A blend of extracts as defined in claim 9, wherein said carvacrol is obtained from an oregano plant that has a ratio of carvacrol to thymol of at least 50:1.

11. A blend of extracts as defined in claim 1, wherein said carvacrol is obtained from an oregano plant of the line KI-Ov1750.

12. A blend of extracts as defined in claim 1, wherein said carvacrol is obtained from an oregano plant that contains not less than 7 mg/g carvacrol on a dry matter basis.

13. A blend of extracts as defined in claim 12, wherein said carvacrol is obtained from an oregano plant that contains not less than 30 mg/g carvacrol on a dry matter basis.

14. A blend of extracts as defined in claim 1, wherein said carvacrol is obtained from an oregano plant that has a ratio of carvacrol to thymol of at least 5:1.

15. A blend of extracts as defined in claim 14, wherein said carvacrol is obtained from an oregano plant that has a ratio of carvacrol to thymol of at least 10:1.

11. A blend of extracts as defined in claim 1, wherein said carvacrol is obtained from an oregano plant of the line KI-Ov1850.
